(19) United States
(12) Patent Application Publication
(10) Pub. No.: US 2014/0240397 A1
(43) Pub. Date: Aug. 28, 2014

(54) DROPLET EJECTION APPARATUS

(71) Applicant: SEIKO EPSON CORPORATION, Tokyo (JP)

(72) Inventor: Norihiro MASUDA, Matsumoto-shi (JP)

(73) Assignee: SEIKO EPSON CORPORATION, Tokyo (JP)

(21) Appl. No.: 14/188,507

(22) Filed: Feb. 24, 2014

(30) Foreign Application Priority Data
Feb. 25, 2013 (JP) 2013-034428

(51) Int. Cl. B41J 2/17

(52) U.S. Cl. CPC B41J 2/1714
USPC 347/34

(57) ABSTRACT

A droplet ejection apparatus including a droplet ejection head that ejects droplets onto a recording medium; a mist suction portion that sucks in mist of the droplets from a suction opening, the mist suction portion being provided downstream of the droplet ejection head in a relative movement direction between the recording medium and the droplet ejection head, and a collection portion that collects the mist sucked in from the suction opening. In the droplet ejection apparatus, a narrowing member that narrows a width of a space of the suction opening in a short direction is provided inside the mist suction portion.

### BACKGROUND

1. Technical Field

The present invention relates to a droplet ejection apparatus.

2. Related Art

Droplet ejection apparatuses with a droplet ejection head that ejects droplets onto a recording medium are already well known. An example of such a droplet ejection apparatus includes an ink jet printer.

Among such droplet ejection apparatuses, some apparatuses include a mist suction portion, which is provided downstream of a droplet ejection head in a relative movement direction between a recording medium and the droplet ejection head and sucks in mist of the droplets, and a collection portion that collects the mist sucked in from the suction opening. JP-A-2005-271314 is an example of related art.

Hitherto, there have been cases in which mist is not appropriately sucked in causing the mist to accumulate in the mist suction portion. In such a case, mist is not appropriately collected by the collection portion.

### SUMMARY

An advantage of some aspects of the invention is to collect mist appropriately.

According to a main aspect of the invention, the droplet ejection apparatus includes a droplet ejection head that ejects droplets onto a recording medium; a mist suction portion that sucks in mist of the droplets from a suction opening, the mist suction portion being provided downstream of the droplet ejection head in a relative movement direction between the recording medium and the droplet ejection head; and a collection portion that collects the mist sucked in from the suction opening. In the droplet ejection apparatus, a narrowing member that narrows a width of a space of the suction opening in a short direction is provided inside the mist suction portion.

Other features of the invention will be apparent from the description of the present specification and the accompanying drawings.

### BRIEF DESCRIPTION OF THE DRAWINGS

The invention will be described with reference to the accompanying drawings, wherein like numbers reference like elements.

FIG. 1 is a block diagram of an overall configuration of a printer.

FIG. 2 is a schematic diagram of a transport path including a print area.

FIG. 3 is a schematic diagram illustrating a basic configuration of a mist collecting unit.

FIG. 4 is a partial cross-sectional schematic diagram of a mist suction portion.

FIG. 5 is a cross-sectional schematic diagram taken along the line V-V of FIG. 4.

FIG. 6 is a schematic diagram of the mist suction portion viewed from below.

FIG. 7 shows partial cross-sectional schematic diagrams of mist suction portions according to a second embodiment.

FIG. 8 is a partial cross-sectional schematic diagram of a mist suction portion according to a third embodiment.

FIG. 9 is a partial cross-sectional schematic diagram of a mist suction portion according to an embodiment that illustrates a state in which mist is accumulated therein.

FIG. 10 is a partial cross-sectional schematic diagram of a mist suction portion according to a fourth embodiment that illustrates a state in which mist is accumulated therein.

FIG. 11 is a schematic diagram of a mist suction portion according to a fifth embodiment viewed from below.

FIG. 12 is a schematic diagram of a mist suction portion according to a sixth embodiment viewed from below.

FIG. 13 is a schematic diagram of a mist suction portion according to a seventh embodiment viewed from below.

FIG. 14 shows partial cross-sectional schematic diagrams of mist suction portions according to an eighth embodiment.

### DESCRIPTION OF EMBODIMENTS

At least the following will become apparent with the description of the present specification and the accompanying drawings.

A droplet ejection apparatus including a droplet ejection head that ejects droplets onto a recording medium; a mist suction portion that sucks in mist of the droplets from a suction opening, the mist suction portion being provided downstream of the droplet ejection head in a relative movement direction between the recording medium and the droplet ejection head; and a collection portion that collects the mist sucked in from the suction opening. In the droplet ejection apparatus, a narrowing member that narrows a width of a space of the suction opening in a short direction is provided inside the mist suction portion.

According to such a droplet ejection apparatus, mist can be appropriately collected.

Furthermore, the narrowing member may be provided such that the narrowing member and a space are aligned alternately in a longitudinal direction of the suction opening.

In such a case, mist can be collected in a more appropriate manner.

Furthermore, the narrowing member may be provided such that a space inside the mist suction portion is separated into a plurality of chambers that align in the longitudinal direction.

In such a case, mist can be collected in a more appropriate manner.

Furthermore, a most upstream end of the narrowing member in a mist suction direction may be positioned on an inner side of the mist suction portion when viewed from the suction opening.

In such a case, mist can be collected in a more appropriate manner.

Furthermore, an upstream end portion of the narrowing member in a mist suction direction may have an inclined edge such that a width of the upstream end portion of the narrowing member becomes larger in the suction direction from an upstream end towards a downstream end.

In such a case, mist can be collected in a more appropriate manner.

Furthermore, a duct forming the space inside the mist suction portion may be provided to extend in an up-down direction, and the narrowing member may be provided up to an upper end of the duct that is provided to extend in the up-down direction.

In such a case, mist can be collected in a more appropriate manner.

### Exemplary Schematic Configuration of Printer 1

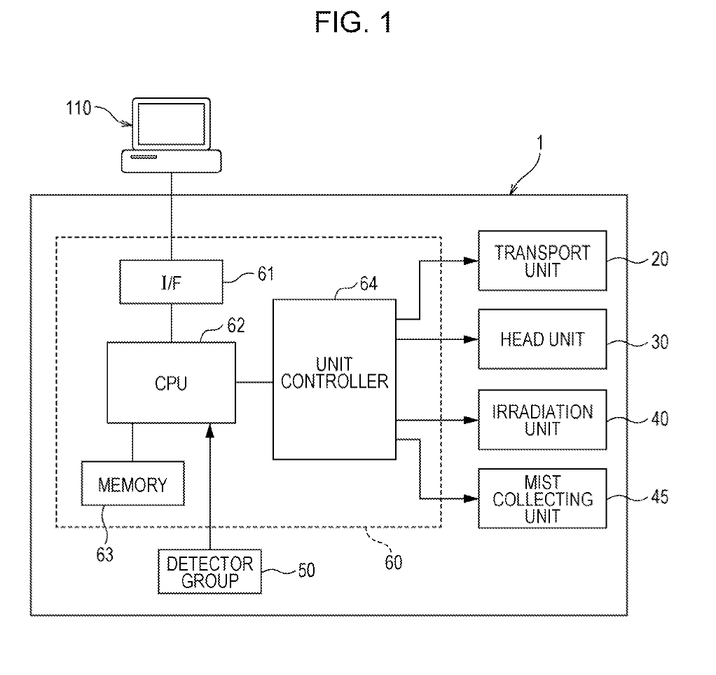

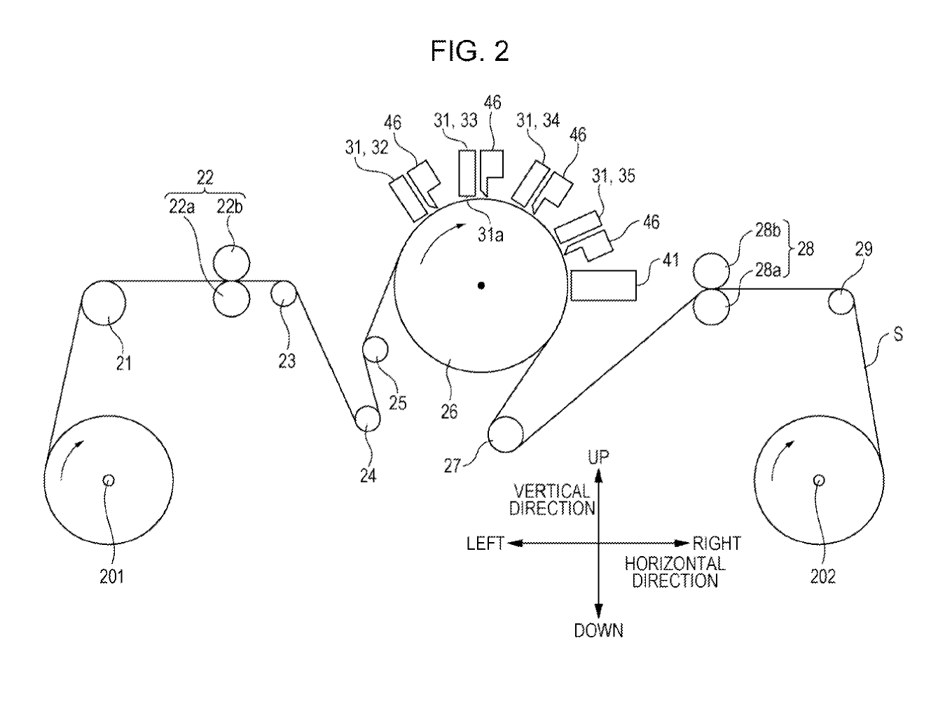

FIG. 1 is a block diagram of an overall configuration of an ink jet printer (hereinafter, simply referred to as a printer 1) that is an example of the droplet ejection apparatus. FIG. 2 is a schematic diagram of a transport path including a print area.

The printer 1 is a printing apparatus that prints images on a recording medium such as paper, fabric, and film and is communicably coupled to an external device such as a computer 110. Note that the present embodiment is described using a sheet of paper that is wound in a roll shape (hereinafter, referred to as roll paper S or continuous paper) as an example of the recording medium on which the printer 1 records images.

A printer driver is installed in the computer 110. The printer driver is a program that displays a user interface on a display device (not shown) and that converts image data obtained by using an application program into print data. The printer driver is recorded on a recording medium (a recording medium that is readable by the computer) such as a flexible disk (FD) or a CD-ROM. Alternatively, the printer driver can be downloaded to the computer 110 via the internet. The program includes codes that implement various functions.

Moreover, the computer 110 outputs print data of the image to be printed to the printer 1 for the printer 1 to print the image.

The printer 1 of the present embodiment is a device that prints images on a medium by ejecting UV curable ink (hereinafter, referred to as UV ink) serving as an example of droplets. The UV curable ink is cured by irradiation of ultraviolet rays (hereinafter, referred to as UV rays). UV ink includes ultraviolet curing resin and is cured by photopolymerization reaction of the ultraviolet curing resin caused by irradiation of UV rays. The printer 1 of the present embodiment prints images using four colors of UV ink, the colors being cyan, magenta, yellow, and black.

The printer 1 includes a transport unit 20, a head unit 30, an irradiation unit 40, mist collecting units 45, a detector group 50, and a controller 60. The printer 1 that has received print data from the computer 110, which is an external device, controls each unit (the transport unit 20, the head unit 30, the irradiation unit 40, and the mist collecting units 45) through the controller 60 and prints an image on the roll paper S according to the print data. The controller 60 controls each unit on the basis of the print data sent from the computer 110 and prints an image on the roll paper S. The status of the printer 1 is monitored by the detector group 50. The detector group 50 outputs the detection result data to the controller 60. The controller 60 controls each unit on the basis of the detection result data output from the detector group 50.

The transport unit 20 transports the roll paper S along a preset transport path. As illustrated in FIG. 2, the transport unit 20 includes a feed shaft 201 around which the roll paper S is wound and by which the roll paper S is supported in a rotatable manner, a relay roller 21, first transport rollers 22, a relay roller 23, an inverting roller 24, a contact roller 25, a transport drum 26, a tension roller 27, second transport rollers 28, a tension roller 29, and a roll paper take-up shaft 202 that takes up the roll paper S having passed the tension roller 29.

The transport drum 26 is a cylindrical transport member that supports the roll paper S with its peripheral surface and transports the roll paper S in the transport direction. Furthermore, the transport drum 26 faces heads 31 and UV irradiation units, which are described below, with the roll paper S between itself and each of the heads 31 and the UV irradiation units. The roll paper S is transported while being in close contact with the transport drum 26 with a predetermined tension.

The roll paper S moves while sequentially passing through each of the rollers; accordingly, a transport path that transports the roll paper S is formed.

The head unit 30 serves as a unit that ejects UV ink onto the roll paper S. The head unit 30 forms dots on the roll paper S and prints an image on the roll paper S by ejecting UV ink from each head 31, which corresponds to a droplet ejection head, onto the roll paper S that is being transported in the transport direction, which corresponds to a relative movement direction between the recording medium and the droplet ejection head.

Note that each head 31 of the head unit 30 of the printer 1 of the present embodiment can form dots in the entire sheet width of the roll paper S, which is a medium, all at once. In other words, each of the heads 31 is a so-called line head. Accordingly, the head 31 is formed long in the sheet width direction (perpendicular direction to the surface of FIG. 2) that is a direction intersecting the transport direction, and nozzles are aligned in the sheet width direction. Each head 31 ejects ink from the nozzles onto the roll paper S that is transported by the transport unit 20 and sequentially and repeatedly prints a raster line (as a result, a plurality of raster lines are aligned in the transport direction).

Note that each nozzle is provided with a piezoelectric element (not shown) serving as a drive element for ejecting ink droplets. When a voltage is applied for a predetermined time between the electrodes provided at the two ends of the piezoelectric element, the piezoelectric element expands in accordance with the application time of the voltage and the sidewall of the flow path of the ink is deformed. Accordingly, the volume of the flow path of the ink decreases with the expansion of the piezoelectric element and an amount of ink corresponding to this decrease in volume is ejected from the nozzle as ink droplets.

In the present embodiment, as described above, four colors of UV ink are used to form an image. As illustrated in FIG. 2, the heads 31, that is, a cyan ink head 32 for ejecting cyan UV ink, a magenta ink head 33 for ejecting magenta UV ink, an yellow ink head 34 for ejecting yellow UV ink, and a black ink head 35 for ejecting black UV ink, are provided in this order from upstream in the transport direction so as to face the peripheral surface of the transport drum 26.

The irradiation unit 40 irradiates UV rays towards the UV ink that has landed on the medium. The dots formed on the medium are cured by being irradiated with UV rays from the irradiation unit 40. The irradiation unit 40 of the present embodiment includes an irradiation portion 41. The irradiation portion 41 includes a lamp (metal halide lamp, mercury lamp, etc.) or an LED as the light source of the UV irradiation.

The irradiation portion 41 is provided downstream of the black ink head 35 in the transport direction. In other words the irradiation portion 41 is provided downstream of the head unit 30 in the transport direction. The irradiation portion 41 irradiates UV rays to the image (dots) formed on the roll paper S with the cyan ink head 32, the magenta ink head 33, the yellow ink head 34, and the black ink head 35 and cures the dots.

The mist collecting units 45 collect mist of the UV ink. The mist collecting units 45 will be described later in detail.

The detector group 50 includes rotary encoders and other detectors. The rotary encoders detect the rotation of a first driving roller 22a and a second driving roller 28a. The transporting amount of the medium can be detected on the basis of the detection result of the rotary encoders.

The controller 60 is a control unit (controller) that controls the printer 1. The controller 60 includes an interface portion 61, a CPU 62, a memory 63, and a unit controller 64. The interface portion 61 carries out transmitting and reception of data between the computer 110, which is an external device, and the printer 1. The CPU 62 is an arithmetic processing unit that controls the entire printer. The memory 63 is a component that secures an area to store a program of the CPU 62 and a working area. The memory 63 includes a storage element such as RAM or EEPROM. The CPU 62 controls each unit through the unit controller 64 on the basis of a program stored in the memory 63.

### Printing Process

The roll paper S is arranged in the transport path and along the peripheral surface of the transport drum 26 before the printer 1 starts printing. Tension is applied to the roll paper S with the output torques of the feed shaft 201, the take-up shaft 202, and the second transport rollers 28. Specifically, a predetermined tension is applied to a feeding portion of the roll paper S with a braking torque of the feed shaft 201, in which the braking torque is set in accordance with the roll diameter of the roll paper S. The tension of the roll paper S in the print area is detected at the tension roller 27 and the torque of a motor (not shown) of the second transport rollers 28 is controlled so that a predetermined tension is applied to the roll paper S in the print area. The tension of the roll paper S at the take-up portion is detected at the tension roller 29 and the torque of a motor (not shown) of the take-up shaft 202 is controlled so that a predetermined tension is applied to the roll paper S at the take-up portion. Each of the above-described tensions is set in accordance with the roll diameter of the roll paper S.

When the printer 1 receives print data from the computer 110, the controller 60 rotates a motor (not shown) of the first transport rollers 22 at a constant speed. As described above, by rotating the first transport rollers 22 at a constant speed while a tension is applied to the roll paper S, the roll paper S is transported in the transport direction at a constant speed. Owing to a frictional force generated between the transport drum 26 and the roll paper S, the transport drum 26 follows the transported roll paper S and rotates in the arrow direction (transport direction).

The roll paper S on the peripheral surface of the transport drum 26 is transported in the transport direction in accordance with the rotation of the transport drum 26. Note that the roll paper S in the midst of transportation adheres to the transport drum 26. Since the position of each head 31 is fixed in the present embodiment, the roll paper S is relatively moved in the transport direction with respect to each head 31 when the roll paper S is transported in the transport direction.

While the roll paper S is transported through the peripheral surface of the transport drum 26, the controller 60 intermittently ejects UV ink from the nozzles of each head 31 of the head unit 30 on the basis of the image data received from the computer 110 (dot forming operation). Accordingly, dots are formed on the roll paper S. Furthermore, the controller 60 irradiates UV rays from the irradiation portion 41 of the irradiation unit 40.

When the roll paper S passes under the cyan ink head 32, the controller 60 ejects cyan ink onto the roll paper S from the cyan ink head 32 and prints cyan. In a similar manner, the controller 60 prints magenta by ejecting magenta ink from the magenta ink head 33 when the roll paper S passes under the magenta ink head 33, prints yellow by ejecting yellow ink from the yellow ink head 34 when the roll paper S passes under the yellow ink head 34, and prints black by ejecting black ink from the black ink head 35 when the roll paper S passes under the black ink head 35. Accordingly, a color image is printed on the roll paper S.

Last of all, the controller 60 irradiates UV rays from the irradiation portion 41 and cures each dot on the roll paper S.

### Mist Collecting Unit 45

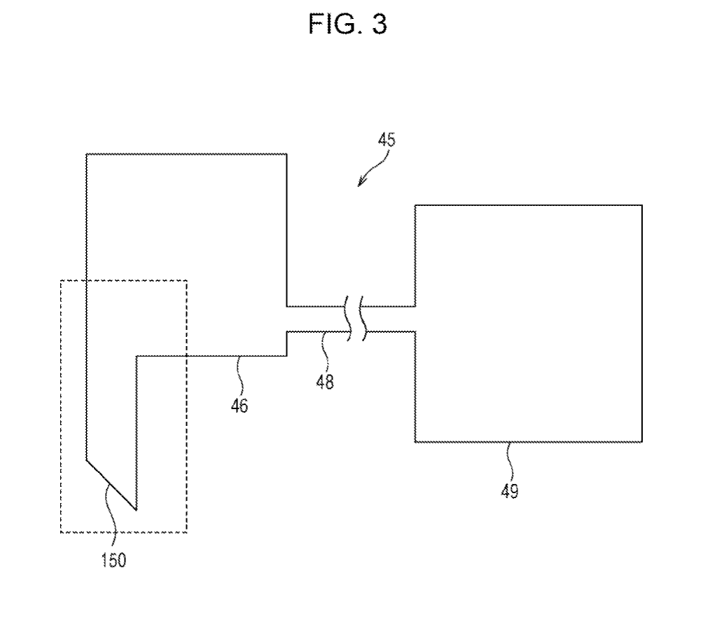

The mist collecting unit 45 will be described next with reference to FIGS. 2 and 3. FIG. 3 is a schematic diagram illustrating a basic configuration of the mist collecting unit 45.

As described above, the mist collecting unit 45 collects mist of the UV ink. As illustrated in FIG. 3, the mist collecting unit 45 includes a mist suction portion 46, a hose 48, and a collection portion 49.

The mist suction portion 46 sucks in mist. The mist suction portion 46 includes a suction opening 150 from which the mist is sucked in. Moreover, a fan described below provided in the collection portion 49 creates a negative pressure inside the mist suction portion 46 such that the mist suction portion 46 sucks in mist together with the air from the suction opening 150.

As illustrated in FIG. 2, a mist suction portion 46 is provided downstream of each of the four heads 31 described above, that is, the cyan ink head 32, the magenta ink head 33, the yellow ink head 34, and the black ink head 35, in the transport direction. In other words, four mist suction portions 46 are provided to correspond to the respective four heads 31.

As described above, the head 31 is long in the sheet width direction. The mist suction portion 46 is accordingly long in the sheet width direction (the direction that is perpendicular to the surface of FIG. 2 and the surface of FIG. 3).

The hose 48 connects the mist suction portion 46 and the collection portion 49. A role of the hose 48 is to send mist that is sucked in by the mist suction portion 46 to the collection portion 49.

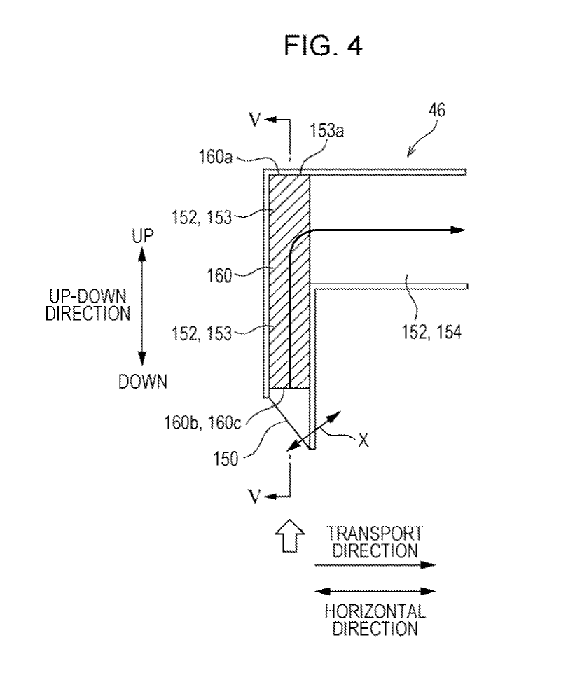

The collection portion 49 collects mist sucked in from the suction opening 150. The collection portion 49 is provided with a fan (not shown). The fan is operated and mist is sucked in from the suction opening 150. The mist passes through a duct 152 (FIG. 4) inside the mist suction portion 46 and through the hose 48, and the mist reaches the collection portion 49. In the collection portion 49, a filter (not shown) is provided in front of the fan. The mist that has reached the collection portion 49 is captured in the filter and is collected.

As illustrated in FIG. 1, the controller 60 controls the mist collecting unit 45. Moreover, when printing is carried out, the controller 60 operates the mist collecting unit 45 and sucks in and collects the mist floating around the head 31. In other words, the controller 60 operates the fan of the mist collecting unit 45 and makes the mist collecting unit 45 collect mist while ejection of UV ink is carried out by the head 31.

### Exemplary Configuration of Mist Suction Portion 46

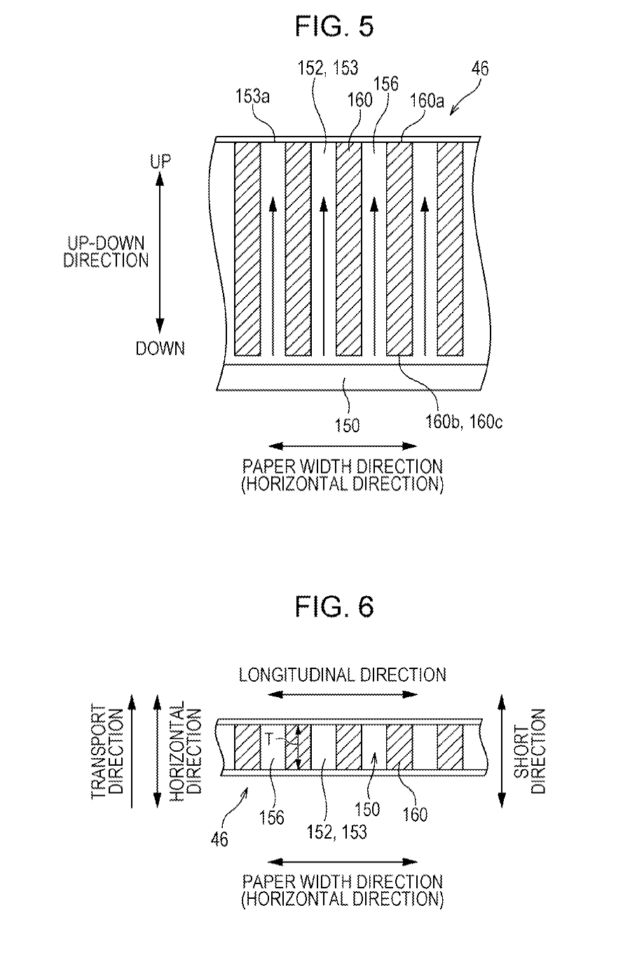

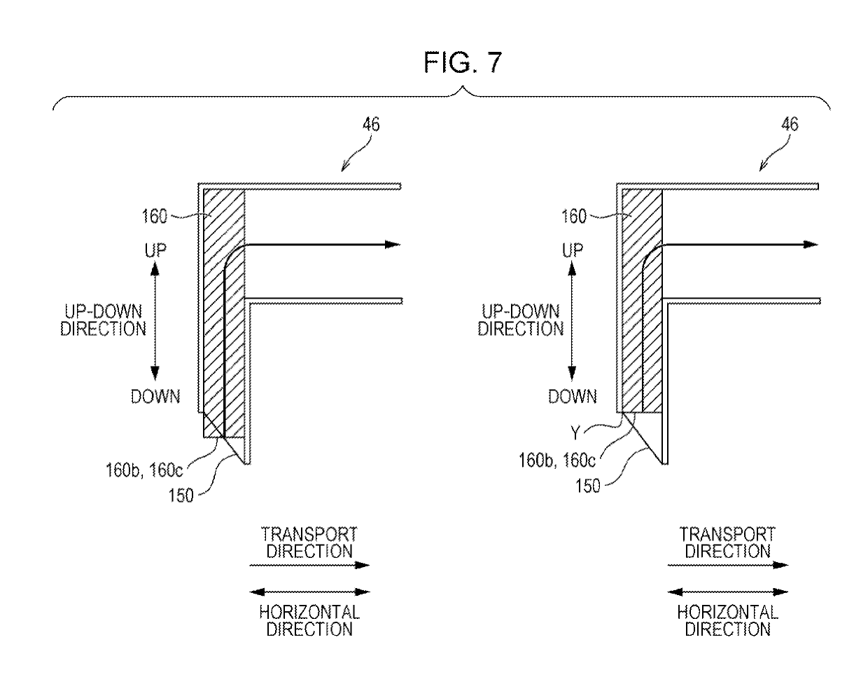

Specific exemplary configurations of the mist suction portion 46 will be described with reference to FIGS. 2 to 10. FIG. 4 is a partial cross-sectional schematic diagram of the mist suction portion 46. FIG. 5 is a cross-sectional schematic diagram taken along the line V-V of FIG. 4. FIG. 6 is a schematic diagram of the mist suction unit 46 viewed from below. FIG. 7 to FIG. 10 will be described later.

FIG. 4 is a cross-sectional schematic diagram of the portion in FIG. 3 surrounded by a dotted line. FIG. 6 is a diagram of the suction opening 150 of the mist suction portion 46 seen from the white arrow direction (from the transport drum 26 side) in FIG. 4.

The four mist suction portions 46 have similar configurations; accordingly, in the below description, among the four mist suction portions 46, the mist suction portion 46 corresponding to the magenta ink head 33 will be described as an example.

The duct 152 serving as a passage (flow path) of the mist that is conveyed together with air is provided in the mist suction portion 46. The duct 152 forms a space in which the mist can move. As described above, the mist suction portion 46 is long in the sheet width direction; accordingly, the duct 152 is also long in the sheet width direction. (See FIGS. 5 and 6. In FIG. 4, the direction penetrating the sheet surface.)

In a section in which the sheet width direction of the mist suction portion 46 is the normal line (in other words, in the section illustrated in FIG. 4), the duct 152 includes a so-called L shape. In other words, as illustrated in FIG. 4, the duct 152 includes a first duct portion 153 extending in the up-down direction (in other words, as illustrated in FIG. 2, the normal line of the nozzle surface 31a of the head 31) and a second duct portion 154 extending in the horizontal direction, which is a direction intersecting the up-down direction.

Furthermore, the suction opening 150 is provided at the lowest end of the first duct portion 153 (in other words, at a position in the first duct portion 153 that is closest to the transport drum 26 described above). The suction opening 150 is also long in the sheet width direction (see FIG. 6). As illustrated in FIG. 4, the normal line of the suction opening 150 that is indicated by an arrow X in FIG. 4 does not extend in the up-down direction but is inclined with respect to the up-down direction. In other words, as illustrated in FIG. 2, the suction opening 150 is oriented towards the head 31. The suction opening 150 is oriented towards the head 31 so that the mist suction portion 46 can effectively suck in the mist around the head 31 from the suction opening 150.

### Configuration and Effects of Spacer 160 According to Present Embodiment

Spacers 160 (the hatched portion) serving as narrowing members are provided inside the mist suction portion 46, in other words, inside the duct 152, in particular, inside the first duct portion 153. The spacers 160 narrow the width of the space of the suction opening 150 in the short direction. Note that narrow refers to a concept including zero narrowness, in other words, the width becoming zero as a result of the narrowing. In other words, the spacers 160 according to the present embodiment each have a rectangular parallelepiped shape and, as illustrated in FIG. 6, are provided inside the mist suction portion 46. The width of the space in the short direction, which would have been T millimeters if there were no spacers 160 therein, is narrowed to zero, zero meaning there is no space.

Moreover, by providing such spacers 160 inside the mist suction portion 46, mist can be appropriately collected.

In other words, as illustrated in FIGS. 5 and 6, by providing the spacers 160 inside the mist suction portion 46, the flow path of the mist, in other words, space, in the duct 152 becomes narrow. Accordingly, the air velocity in the flow path (space) during suction becomes faster, thus, the mist can be sucked in quickly. Accordingly, occurrence of a phenomenon such as mist accumulating inside the mist suction portion 46 and dripping on the roll paper S can be adequately suppressed.

As illustrated in FIGS. 5 and 6, the spacers 160 are provided in the longitudinal direction of the suction opening 150 such that a spacer 160 and a space are aligned alternately.

Such alignment allows narrow portions of the flow path (space) to exist uniformly throughout the longitudinal direction of the suction opening 150; accordingly, mist can be collected appropriately. In the present embodiment, spacers 160 are provided in a plural number in the whole area of the mist suction portion 46 in the longitudinal direction.

Furthermore, as illustrated in FIG. 6, the spacers 160 are provided so as to separate the space inside the mist suction portion 46 (inside the duct 152) into a plurality of chambers 156 (in other words, rooms) aligned in the longitudinal direction of the mist suction portion 46.

This allows the air velocity in the chambers 156 to be surely increased and mist to be collected more appropriately.

In the present embodiment, as illustrated in FIGS. 4 and 5, the most upstream end 160b of each spacer 160 in the mist suction direction (indicated by a black arrow in FIGS. 4 and 5) is positioned on the inner side of the mist suction portion 46 when viewed from the suction opening 150. In other words, a lower end 160c of each spacer 160 is all positioned on the inner side of the mist suction portion 46 with respect to the suction opening 150.

Different from the present embodiment, as illustrated on the left side of FIG. 7, when the most upstream end 160b is positioned on the outer side of the mist suction portion 46 when viewed from the suction opening 150, or as illustrated on the right side of FIG. 7, when the most upstream end 160b is positioned at the suction opening 150 (refer to a position indicated by a reference character Y in the right figure), then the most upstream end 160b is exposed to the outside of the mist suction portion 46 and, thus, is scarcely hit by the air flow generated by the suction operation; accordingly, mist may adhere to the most upstream end 160b, remain there, and accumulate thereon.

Conversely, in the present embodiment, since the most upstream end 160b is positioned on the inner side of the mist suction portion 46 when viewed from the suction opening 150, the most upstream end 160b is appropriately hit by the air flow described above in the mist suction portion 46; accordingly, occurrence of the above-described mist accumulating phenomenon is suppressed.

Therefore, the present embodiment is desirable than the example of FIG. 7 (referred to as a second embodiment) in that mist can be collected more appropriately. FIG. 7 is a diagram corresponding to FIG. 4 and is a partial cross-sectional schematic diagram of the mist suction portion 46 according to the second embodiment.

As illustrated in FIGS. 4 and 5, the spacers 160 are formed up to an upper end 153a of the duct 152, in other words, the spacers 160 are formed up to the upper end 153a of the first duct portion 153 described above that is provided to extend in the up-down direction. In other words, the spacer 160 is in contact with the so-called celling portion of the first duct portion 153.

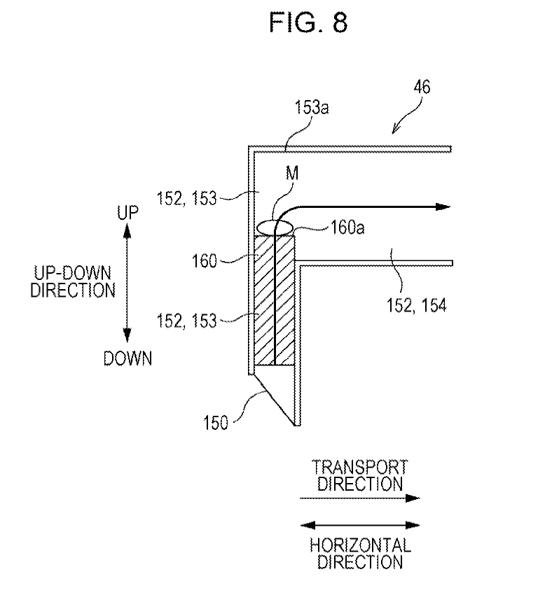

Different from the present embodiment, as illustrated in FIG. 8, when the spacers 160 are not formed up to the upper end 153a of the first duct portion 153 (when not in contact with the ceiling portion), then, mist may accumulate on the upper end 160a of the spacer 160 (the accumulated mist is denoted by a character M) and the accumulated mist may drop down.

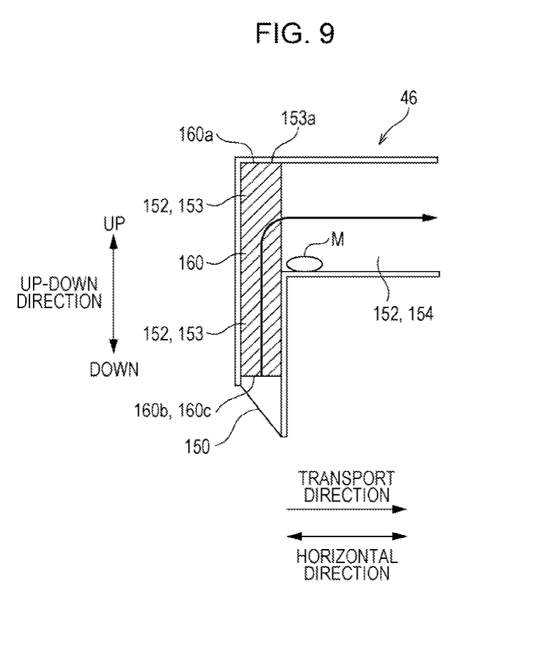

Conversely, in the present embodiment, as illustrated in FIG. 9, since the spacers 160 are formed up to the upper end 153a of the first duct portion 153 (the spacers 160 are in contact with the ceiling portion), mist does not accumulate on the upper end 160a (even if the mist accumulates thereon, as illustrated in FIG. 9, the mist will accumulate in the second duct portion 154). Accordingly, the possibility of the mist dropping phenomenon occurring becomes lower. Therefore, the present embodiment is desirable than the example of FIG. 8 (referred to as a third embodiment) in that mist can be collected more appropriately.

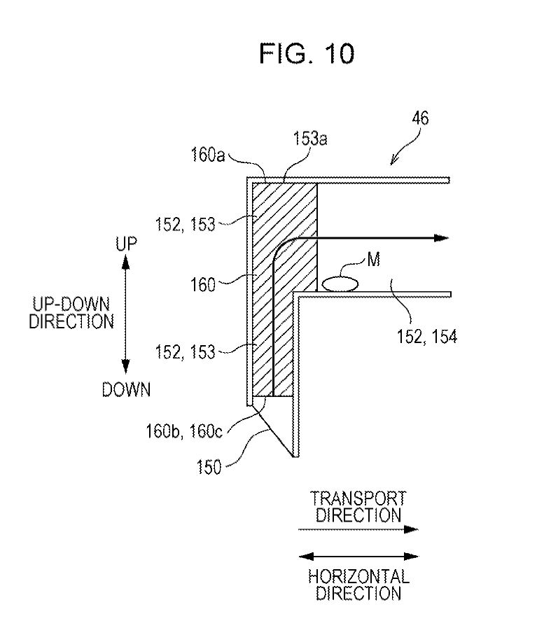

Furthermore, as illustrated in FIG. 10, the spacer 160 may advance into the second duct portion 154. Even in such a case (referred to a fourth embodiment) as well, similar to the example of FIG. 9, mist does not accumulate on the upper end 160a; accordingly, the occurrence of the mist dropping phenomenon can be suppressed.

FIG. 8 to FIG. 10 are diagrams corresponding to FIG. 4. FIG. 8 is a partial cross-sectional schematic diagram of the mist suction portion 46 according to the third embodiment. FIG. 9 is a partial cross-sectional schematic diagram of the mist suction portion 46 according to an embodiment that illustrates a state in which mist is accumulated therein. FIG. 10 is a partial cross-sectional schematic diagram of the mist suction portion 46 according to the fourth embodiment that illustrates a state in which mist is accumulated therein.

### Other Embodiments

The above-described embodiments are for facilitating understanding of the invention and are not meant to limit the interpretation of the invention. The invention may be modified or altered in various ways without departing from the spirit and scope thereof, and it goes without saying that equivalents thereof are included in the invention. In particular, the embodiments described below are included in the invention.

In the above embodiments, line heads are employed as the droplet ejection heads; however, serial heads in which the droplet ejection heads scan in a direction that intersects the transport direction of the recording medium may be employed. In such a case, irradiation units may be each arranged on the two sides of the scanning direction of the serial head, and the mist suction portion may be arranged between the head and the irradiation unit.

In each of the above embodiments, a droplet ejection apparatus (a liquid ejecting apparatus) is implemented in an ink jet printer; however, a droplet ejection apparatus (liquid ejecting apparatus) that discharges or ejects droplets (liquid) other than ink can be employed. Accordingly, the droplet ejection apparatus (the liquid ejecting apparatus) can be applied to various liquid ejecting apparatuses provided with a liquid ejection head or the like for ejecting minute amount of droplets. Note that droplet refers to a state of a liquid that is ejected from the liquid ejecting apparatus described above and its shape includes a granular shape, a tear shape, or a shape with a threadlike trail. Liquid used herein refers to any material that can be ejected by the liquid ejecting apparatus. For example, any material in a liquid state is sufficient, such as a material in a liquid state with high or low viscosity, sol, gel water, other inorganic solvents, an organic solvent, a solution, liquid resin, and liquid metal (metallic melt) that is in a flow regime. Furthermore, not just liquid as a state of matter, the material includes particles of functional material including a solid body such as pigment or metal particle that is dissolved, dispersed, or mixed in a solvent. A representative example of the liquid includes ink, liquid crystal, and others described above in the embodiment. Note that ink includes a variety of liquid compositions such as a general aqueous ink, solvent ink, and gel ink, and a hot melt ink. Specifically, examples of the liquid ejecting apparatus may include a liquid ejecting apparatus that ejects liquid material, in a dispersed or dissolved manner, such as an electrode material or a color material to be used to manufacture liquid crystal displays, electroluminescence (EL) displays, surface emitting displays, and color filters; a liquid ejecting apparatus that ejects bio organic matter to manufacture biochips; a liquid ejecting apparatus used as a precision pipette that ejects liquid serving as a sample; a printing equipment; and a microdispenser. Furthermore, the liquid ejecting apparatus may be adopted by a liquid ejecting apparatus for ejecting lubricating oil in a pinpoint manner onto a precision instrument such as a clock or a camera, a liquid ejecting apparatus for spraying transparent liquid resin such as ultraviolet curing resin on a substrate in order to form a hemispherical microlens (optical lens) to be used in optical communication elements, a liquid ejecting apparatus for ejecting acid solution, alkaline solution, or another etching solution for etching substrates and the like. The invention can be applied to either one of the ejecting apparatuses described above.

In the above-described embodiments, roll paper S is cited as an example of the recording medium; however, not limited to the roll paper S, the recording medium may be, for example, cut paper. The recording medium is not limited to paper but may be, for example, film or fabric.

In the above-described embodiments, a cylindrical member including a curved surface (in other words, the transport drum 26) is cited as an example of the member that faces the head 31 and that supports the roll paper S; however, not limited to the cylindrical member, a member including a flat surface, for example, may be employed.

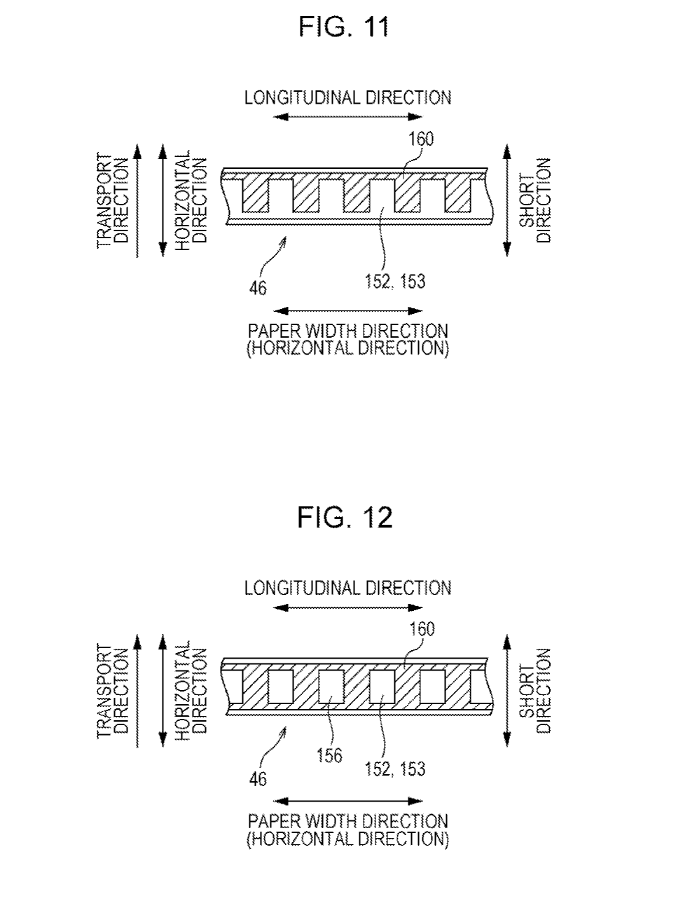

In the above-described embodiments, the spacers 160 are provided so as to separate the space inside the mist suction portion 46 (inside the duct 152) into the plurality of chambers 156 (in other words, rooms) aligned in the longitudinal direction of the mist suction portion 46; however, the arrangement is not limited to the above arrangement. For example, as illustrated in FIG. 11, the spacer 160 may not separate the space into a plurality of chambers. FIG. 11 is a diagram corresponding to FIG. 6 and is a schematic diagram of the mist suction portion 46 according to a fifth embodiment viewed from below.

In the above-described embodiments, a plurality of spacers 160 are provided; however, the number is not limited to the above. For example, as illustrated in FIGS. 11 and 12, the spacer 160 may not be provided in a plural number. The example of FIG. 12 is different from that of FIG. 11 and is an example in which the spacer 160 separates the space into the plurality of chambers 156. FIG. 12 is a diagram corresponding to FIG. 6 and is a schematic diagram of the mist suction portion 46 according to a sixth embodiment viewed from below.

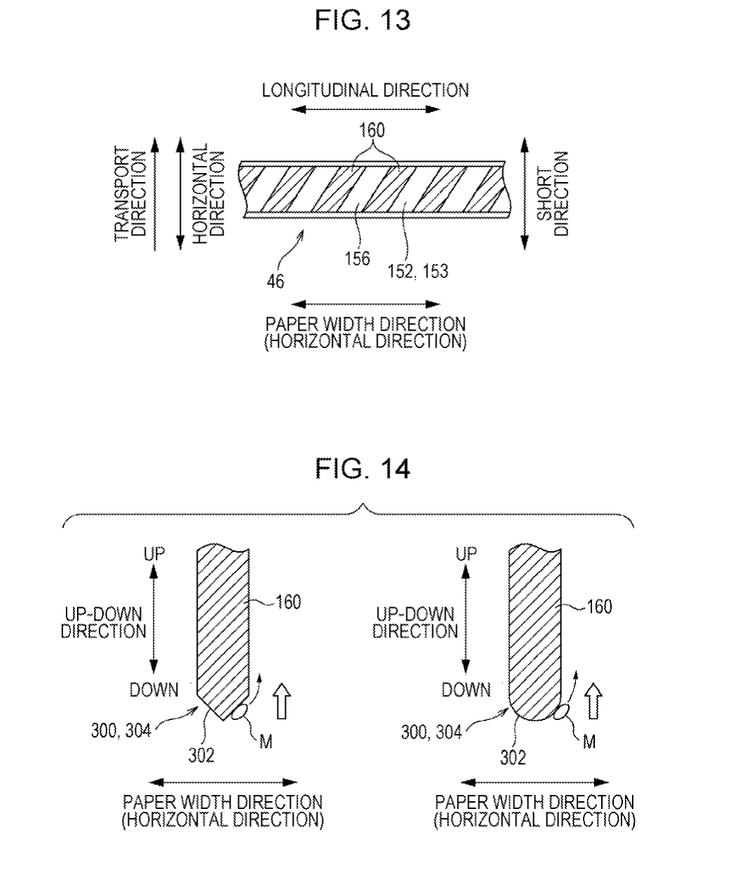

In the above-described embodiments, as illustrated in FIG. 6, when the mist suction portion 46 is viewed from below, the spacer 160 is provided such that the longitudinal direction of the spacer 160 extends in the short direction of the suction opening 150; however, the arrangement of the spacer 160 is not limited to the above arrangement. For example, as illustrated in FIG. 13, when the mist suction portion 46 is viewed from below, the longitudinal direction of the spacer 160 may neither extend in the short direction nor in the longitudinal direction of the suction opening 150 and the spacer 160 may be provided obliquely. FIG. 13 is a diagram corresponding to FIG. 6 and is a schematic diagram of the mist suction portion 46 according to a seventh embodiment viewed from below.

As illustrated in FIG. 14, an upstream end portion 300 of the spacer 160 in the mist suction direction may have an inclined edge 302 such that the width of the upstream end portion of the spacer 160 becomes larger in the suction direction from the upstream end towards the downstream end, in other words, in the direction of the white arrow, the width of the inclined edge 302 becomes larger. In other words, the lower end portion 304 of the spacer 160 may have the inclined edge 302 in which the width becomes larger from the lower end towards the upper end.

For example, the upstream end portion 300 (the lower end portion 304) provided with the inclined edge 302 may have, as illustrated in the left diagram of FIG. 14, a triangle shape or, as illustrated in the right diagram of FIG. 14, an arc shape.

Since such inclinations 302 are provided, as illustrated in FIG. 14, even if mist M adheres to the upstream end portion 300 (the lower end portion 304), the mist M will move towards the downstream side in the suction direction more easily, that is, the mist M will move upwards more easily owing to the effect of the inclinations 302. Accordingly, mist can be collected in a more appropriate manner.

FIG. 14 is a diagram that partially corresponds to FIG. 5 and is a partial cross-sectional schematic diagram of the mist suction portion 46 according to an eighth embodiment.

The entire disclosure of Japanese Patent Application No. 2013-034428, filed Feb. 25, 2013 is expressly incorporated by reference herein.

What is claimed is:

1. A droplet ejection apparatus, comprising:
a droplet ejection head that ejects droplets onto a recording medium;
a mist suction portion that sucks in mist of the droplets from a suction opening, the mist suction portion being provided downstream of the droplet ejection head in a relative movement direction between the recording medium and the droplet ejection head; and
a collection portion that collects the mist sucked in from the suction opening, wherein
a narrowing member that narrows a width of a space of the suction opening in a short direction is provided inside the mist suction portion.

2. The droplet ejection apparatus according to claim 1, wherein
the narrowing member is provided such that the narrowing member and a space are aligned alternately in a longitudinal direction of the suction opening.

3. The droplet ejection apparatus according to claim 2, wherein
the narrowing member is provided such that a space inside the mist suction portion is separated into a plurality of chambers that align in the longitudinal direction.

4. The droplet ejection apparatus according to claim 1, wherein
a most upstream end of the narrowing member in a mist suction direction is positioned on an inner side of the mist suction portion when viewed from the suction opening.

5. The droplet ejection apparatus according to claim 1, wherein
an upstream end portion of the narrowing member in a mist suction direction has an inclined edge such that a width of the upstream end portion of the narrowing member becomes larger in the suction direction from an upstream end towards a downstream end.

6. The droplet ejection apparatus according to claim 1, wherein
a duct forming the space inside the mist suction portion is provided to extend in an up-down direction, and
the narrowing member is provided up to an upper end of the duct that is provided to extend in the up-down direction.
